(19) United States
(12) Patent Application Publication
(10) Pub. No.: US 2025/0384862 A1
(43) Pub. Date: Dec. 18, 2025

(54) KARAOKE MODULE FOR USE IN A VEHICLE AND VEHICLE WITH A KARAOKE MODULE

(71) Applicant: AUDI AG, Ingolstadt (DE)

(72) Inventors: Jacques HELOT, Ingolstadt (DE); Christian WALL, Hitzhofen (DE)

(73) Assignee: AUDI AG, Ingolstadt (DE)

(21) Appl. No.: 19/215,442

(22) Filed: May 22, 2025

(30) Foreign Application Priority Data
Jun. 14, 2024 (DE) 102024116775.0

(51) Int. Cl. G10H 1/36; B60R 11/02; B60R 16/033; H04R 1/02; H04R 1/08; H04R 3/00

(52) U.S. Cl. CPC G10H 1/361; B60R 16/033; H04R 1/025; H04R 1/08; H04R 3/00; B60R 11/0247; G10H 2210/005; H04R 2499/13

(57) ABSTRACT

Portable karaoke module with a vehicle-integrated audio system, having at least one microphone and a housing in which at least one loudspeaker, an electronic control unit for selectively outputting audio signals via the loudspeaker, and a rechargeable energy storage device for supplying energy to the loudspeaker and the control unit. An operating unit for manual function control and at least one microphone receptacle for mechanically receiving the microphone are provided on an outer side of the housing. The housing is received in a corresponding module receptacle in the vehicle, and the control unit outputs the audio signals via the loudspeaker when the housing is not accommodated in the module receptacle, and otherwise outputs the audio signals automatically via the audio system of the vehicle.

### FIELD

The invention relates to a karaoke module for use in a vehicle and a vehicle with a karaoke module.

### BACKGROUND

Karaoke is a popular pastime in which people sing live into a microphone to an instrumental playback of well-known pieces of music. The instrumental playback and the signals recorded by the microphone can be mixed by the karaoke module and output together via a loudspeaker.

There are various rack options for additional external components in vehicles. Both the racks and the components usually vary in shape and size. For example, karaoke microphones are offered for use in vehicles. These are paired with the vehicle via Bluetooth and are output via the vehicle speakers.

The microphones often do not have their own storage space and cannot be used independently outside the vehicle.

For example, GB 2484084 A discloses a portable karaoke device with microphones, music playback and control unit. The karaoke device can be paired with a vehicle's audio system.

Furthermore, DE 3513017 A1 describes a vehicle audio system with a karaoke device, of which a control part and a display part are arranged in a center console or a dashboard of the vehicle and other parts are arranged in separate, concealed places.

CN 201261432 Y discloses an external karaoke device for a vehicle. The external karaoke device can be mounted in various regions of the vehicle.

### SUMMARY

Against this background, the object of the invention is to provide a karaoke module for use in a vehicle and a vehicle with a karaoke module, which can provide the aforementioned karaoke functions with less construction effort and at low cost.

This object is achieved by a karaoke module with the features of claim 1 and by a vehicle with the features of claim 8. Further, particularly beneficial embodiments of the invention are disclosed by the respective dependent claims.

It should be noted that the features listed individually in the claims can be combined in any technically useful way (also across category boundaries, for example between the method and the device) and show further embodiments of the invention. The description characterizes and specifies the invention in particular in relation to the figures additionally.

It should also be noted that a conjunction “and/or” used here, which is between two features and which links them to each other, must always be interpreted in such a way that only the first feature can be present in an initial design of the object of the invention, the second feature can only be present in a second design, and both the first and the second feature can be present in a third design.

The invention relates to a portable karaoke module for use in a vehicle, which has a vehicle-integrated audio system (i.e. at least one vehicle loudspeaker and a vehicle control unit for selectively outputting audio signals via the vehicle loudspeaker), wherein the portable karaoke module has at least one microphone and a housing in which at least one loudspeaker, an electronic control unit for selectively outputting audio signals, such as a piece of music, an instrumental playback and/or signals picked up by the microphone via the loudspeaker (optionally with the interposition of an amplifier for amplifying the audio signals to be output) and a rechargeable energy store for supplying energy to the loudspeaker and the control unit. Furthermore, an operating unit for manual function control of the karaoke module and at least one microphone receptacle for mechanically holding the microphone are provided on an outer side of the housing. According to the invention, the housing is designed to be received in a corresponding module receptacle in the vehicle, and the control unit is designed to output the audio signals via the loudspeaker when the housing is not received in the module receptacle of the vehicle, and otherwise to output the audio signals automatically via the audio system of the vehicle (e.g. the vehicle loudspeaker).

If the karaoke module is pushed into the module receptacle of the vehicle, the karaoke module automatically begins to pair with the vehicle or with a vehicle control unit. The functionality of the karaoke module's speaker is deactivated. When arranged in the vehicle, the entire karaoke module (i.e. including at least one microphone) is always held securely in the vehicle with minimal structural effort and in a space-saving manner. In addition, it is designed to have full functionality outside the vehicle and to be able to be used as intended independently of it.

In an advantageous embodiment, the microphone receptacle has a push-push locking mechanism for holding the microphone. This means that to remove the microphone from the microphone receptacle, the microphone is moved a short distance beyond the locked position in the locking direction. This short movement in the locking direction beyond the locked position, in which the microphone is securely held in the receptacle, releases the lock. The push-push locking mechanism is unlocked and the microphone can be removed from the receptacle or at least partially extended by spring action.

In other preferred embodiments, the microphone receptacle is designed as a hollow cylinder. This has a height that essentially corresponds to the length of the microphone. This means that when the microphone is fully inserted into the microphone receptacle, it sits flush with the housing (e.g. a top). In addition to a particularly space-saving arrangement, this design avoids any risk of injury from a microphone that would otherwise be partially exposed or protrude from the housing when arranged in the vehicle.

The hollow cylinder preferably has a diameter that is only slightly larger than the diameter of the microphone so that the microphone is held securely in the microphone receptacle without tilting.

In further advantageous embodiments, the karaoke module has a detection device coupled to the control unit (e.g. a mechanical switch, Hall sensor, RFID, near field communication (NFC) or similar), which is designed to detect the reception or insertion of the housing into the module receptacle of the vehicle and to signal the detected reception to the control unit. In this case, the control unit of the karaoke module can automatically start the output of the audio signals via the audio system, i.e. a vehicle speaker.

Alternatively or additionally, the vehicle may have a detection device with the same function, so that the vehicle can automatically initiate a coupling of the audio system with the portable karaoke module inserted into the module receptacle.

According to another advantageous embodiment, the karaoke module has an energy transmission device coupled to the rechargeable energy storage device, which is designed to transmit electrical energy provided by the vehicle into the rechargeable energy storage device and to charge it when the housing is received in the module receptacle of the vehicle. The energy transmission device may, for example, be a contact-based electrical connection or a transmission device that provides wireless, e.g. inductive, energy transmission.

In further preferred embodiments, a device receptacle for a mobile terminal (e.g. smartphone, tablet, laptop or similar) is provided on the outside of the housing. In addition to providing secure and space-saving storage for the mobile device, it can be used to transmit audio signals, such as a piece of music, an instrumental playback, and the like, to the control unit of the karaoke module.

The operating unit of the karaoke module can be designed and used to control functions of the mobile device, for example when the device is in the device receptacle.

In advantageous other embodiments, the control unit is designed to detect removal of the microphone from the microphone receptacle and, in this case, to start the output of the audio signals via the loudspeaker on the karaoke module side and/or the audio system of the vehicle. If the at least one microphone is removed from the karaoke module, a karaoke menu can be automatically displayed on a display in the vehicle, for example, with which a vehicle occupant can control the karaoke functions of the karaoke module.

Furthermore, the invention relates to a vehicle having an integrated audio system, which in turn has at least one vehicle loudspeaker and a vehicle control unit for outputting audio signals via the vehicle loudspeaker. Furthermore, the vehicle has a module receptacle which is designed to receive a portable karaoke module according to one of the embodiments disclosed herein. The portable karaoke module is safely positioned in the vehicle. In addition, the karaoke module is automatically paired with the vehicle's audio system when the karaoke module is inserted into the module receptacle.

It should be understood that, with regard to vehicle-related definitions and the effects and benefits of vehicle features, full recourse can be made to the disclosure of meaningful definitions, effects and benefits of the karaoke module according to the invention and vice versa. A repetition of explanatory notes, mutatis mutandis, of the same characteristics, the effects and advantages of which can therefore be omitted in favor of a more compact description, without such omissions being interpreted as a restriction on one of the disclosed inventions.

In a preferred embodiment, the module receptacle is arranged in a center console of the vehicle. This allows easy access to the karaoke module (e.g. for operation via the operating unit on the karaoke module side, for removing the microphone, etc.) from different seats (e.g. driver's seat, front passenger seat, rear seat) in the vehicle.

In another advantageous embodiment, the module receptacle is designed as a recess (e.g. in the center console) which has an insertion depth that essentially corresponds to a height of the housing of the karaoke module. This allows the portable karaoke module to be completely recessed into the module receptacle and, for example, to be flush with the top of the center console. In addition to an appealing visual impression, a potential risk of injury from components of the karaoke module protruding into the vehicle interior is avoided.

### BRIEF DESCRIPTION OF THE FIGURES

Further features and advantages of the invention result from the following description of non-restrictive exemplary embodiments of the invention, which are explained in more detail below with reference to the drawing. In the figures, schematically:

FIG. 1 is a functional diagram of a portable karaoke module according to an embodiment of the invention;

FIG. 2 is a perspective view of a portable karaoke module according to another embodiment of the invention;

FIG. 3 is a plan view of a region of an interior of a vehicle according to an embodiment of the invention when using the karaoke module from FIG. 2 according to a first possibility;

FIG. 4 is a plan view of the region of the interior of the vehicle from FIG. 3 when using the karaoke module from FIG. 2 according to a second possibility; and

FIG. 5 is a plan view of the region of the interior of the vehicle from FIG. 4 when using the karaoke module from FIG. 2 according to a second possibility.

### DETAILED DESCRIPTION

In the different figures, equivalent parts are always marked with the same reference numerals in terms of their function, so that they are usually described only once.

The concrete exemplary embodiments described below are purely exemplary in nature to illustrate the basic structures and processes.

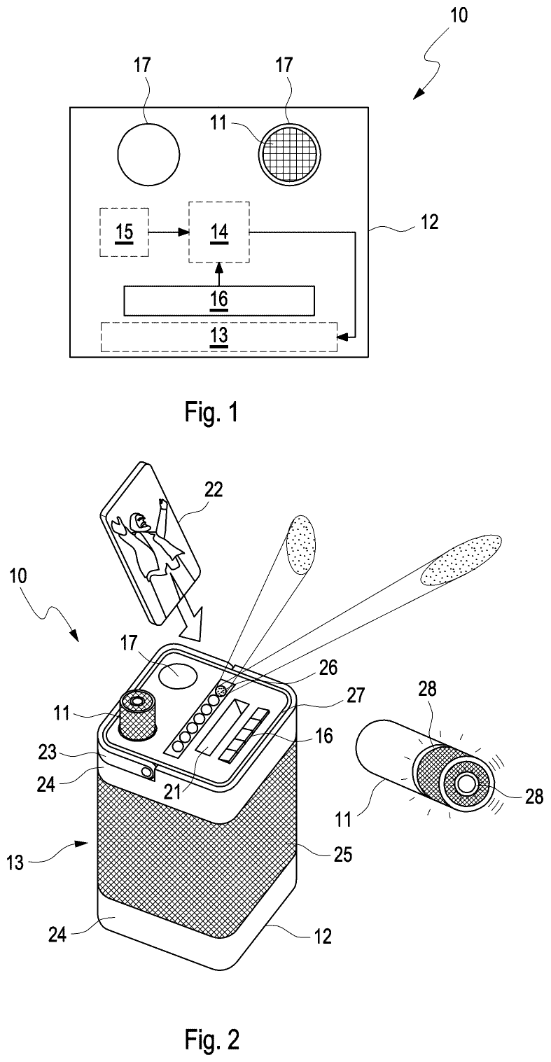

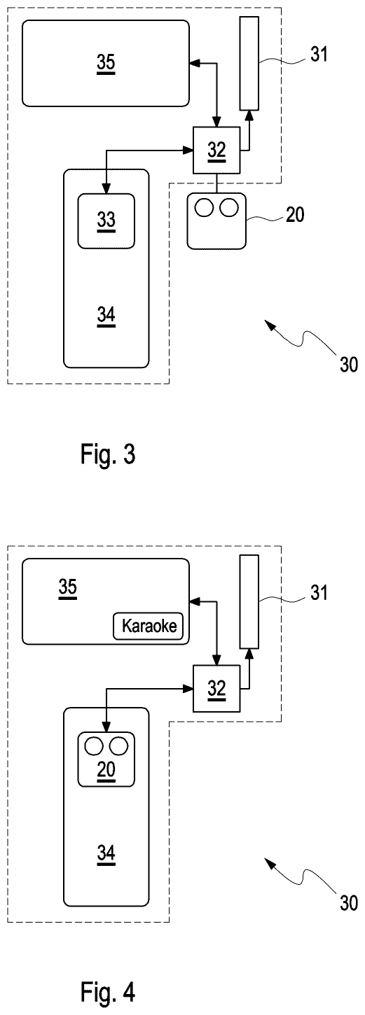

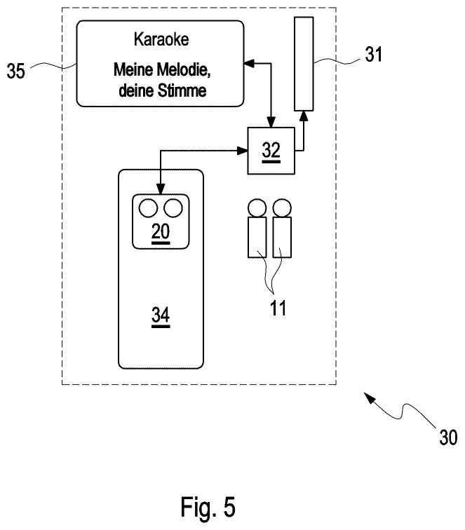

FIG. 1 is a functional diagram of a portable karaoke module 10 according to an embodiment of the invention. The karaoke module 10 is designed to be used both autonomously, i.e. independently of a vehicle (see FIG. 3), and in a vehicle (see FIGS. 4 and 5), as will be explained in more detail below.

The portable karaoke module 10 shown in FIG. 1 has at least one microphone 11, preferably two microphones 11, of which only one is shown in FIG. 1, and a housing 12. In the present case, the housing 12 contains a loudspeaker 13, an electronic control unit 14 for selectively outputting audio signals via the loudspeaker 13 and a rechargeable energy storage device 15 for supplying energy to the loudspeaker 13 and the control unit 14. On an outer side of the housing 12, an operating unit 16 for manual function control of the karaoke module 10 and, in the present case, two microphone receptacles 17 for mechanically holding the microphone 11 are provided. The control unit 16 can have several control elements, for example buttons, switches, rotary knobs and the like.

The microphone receptacle 17 preferably has, but is not necessarily limited to, a push-push locking mechanism for receiving the microphone 11.

The microphone receptacle 17 in the karaoke module 10 shown in FIG. 1 is designed as a hollow cylinder into which the microphone 11 can be completely sunk, so that an upper side of the microphone 11 is flush with an upper side of the housing 10 when the microphone 11 is completely received in the microphone receptacle 17.

FIG. 2 shows a perspective view of a karaoke module 20 according to another embodiment of the invention. The karaoke module 20 differs from the karaoke module 10 shown in FIG. 1 essentially in that it provides a device receptacle 21 for a mobile terminal device 22 (in the present case and without mandatory limitation to this, a smartphone) on the outside of the housing 12. The mobile terminal device 22 can be coupled to the control unit 14 of the karaoke module 20 in a data-transmitting manner in order to transmit, for example, a piece of music, an instrumental playback or the like to the control unit 14, which outputs the associated audio signals via the loudspeaker 13.

Additionally, FIG. 2 shows a carrying handle 23 attached to the housing 12. Furthermore, the karaoke module 20 has, by way of example and without any mandatory limitation thereto, a fabric covering 25 held between an upper and a lower metal ring 24 (e.g. aluminum rings), which covers the loudspeaker 13 so that it cannot be seen in FIG. 2. Furthermore, on an upper side of the karaoke module 20, there are arranged, for example, lighting elements 26 in the form of individual LEDs and a light ring 27 which essentially follows a contour of the upper side of the housing.

In FIG. 2, one of the two microphones 11, which is removed from one of the two microphone receptacles 17, is also shown in a perspective view. In the present embodiment, the microphone 11 has, for example, light elements 28 which can indicate by means of corresponding light signals when to sing into the microphone 11. The microphone 11 may additionally comprise a vibration generating unit (not shown) which may, for example, indicate that a vocal volume is too high.

FIG. 3 is a plan view of a region of an interior of a vehicle 30 according to an embodiment of the invention when using the karaoke module 20 from FIG. 2 according to a first possibility;

The vehicle 30 has an integrated audio system that includes at least one vehicle loudspeaker 31 and a vehicle control unit 32 for selectively outputting audio signals via the vehicle loudspeaker 31. Furthermore, the vehicle 30 has a module receptacle 33 which is designed to receive a portable karaoke module (e.g. the portable karaoke module 10 or 20). In the exemplary embodiment shown here, the module receptacle 33 is arranged in a center console 34 of the vehicle 30, but is not necessarily limited thereto.

Preferably, the module receptacle 33 is designed as a recess in the center console 34 into which the karaoke module 20 can be fully inserted, so that the top of the karaoke module 20 is flush with the center console 34 when the karaoke module 20 is fully inserted into the module receptacle 33.

The housing 12 of the portable karaoke module 20 (as well as the housing 12 of the karaoke module 10 shown in FIG. 1) is designed to be received in the corresponding module receptacle 33. Furthermore, the control unit 14 of the karaoke module 20 (as well as that of the karaoke module 10) is designed to output the audio signals via the karaoke module's own loudspeaker 13 when the housing 12 is not received in the module receptacle 33, and otherwise to output the audio signals automatically via the audio system of the vehicle 30, i.e. via the vehicle loudspeaker 31.

FIG. 3 shows the situation in which the karaoke module 20 can be used independently of the vehicle 30, ie autonomously. The control unit 14 of the karaoke module 20 (as well as that of the karaoke module 10) is designed to output the audio signals via the loudspeaker 13 on the karaoke module side, since the housing 12 of the karaoke module 20 is not accommodated in the module receptacle 33 of the vehicle 30.

FIG. 4 shows a plan view of the area of the interior of the vehicle 30 from FIG. 3 when using the karaoke module 20 from FIG. 1 according to a second possibility in which the karaoke module 20 is received in the module receptacle 33. The control unit 14 of the karaoke module 20 (as well as that of the karaoke module 10) is designed to output the audio signals via the vehicle loudspeakers 31, since the housing 12 of the karaoke module 20 is received in the module receptacle 33 of the vehicle 30.

If the karaoke module 20 is pushed into the module receptacle 33, the control unit 14 can automatically establish a communication connection with the vehicle control unit 32. For this purpose, the karaoke module 20 can have a detection device (not shown) coupled to the control unit 14, which is designed to detect the reception of the housing 12 in the module receptacle 33 and to signal the detected receptacle to the control unit 14 in order to establish the coupling of the karaoke module 20 to the vehicle 30. Alternatively or additionally, a functionally identical detection device may be present in the vehicle 30, so that the coupling can be initiated by the vehicle 30 as soon as the vehicle-side detection device detects that the karaoke module 20 has been inserted into the module receptacle 33.

After the karaoke module 20 is coupled to the vehicle 30 or the vehicle control unit 32, this can be displayed accordingly on a display 35 of the vehicle 30, as indicated in FIG. 4 by the lettering “Karaoke”.

FIG. 5 shows a plan view of the area of the interior of the vehicle 30 from FIG. 4 during use of the karaoke module 20 from FIG. 1 according to the second possibility, wherein at least one of the microphones 11 is removed from its microphone receptacle 17. The control unit 14 of the karaoke module 20 (as well as that of the karaoke module 10) can be designed to detect the removal of the microphone 11 from the microphone receptacle 17 and, in this case, to start the output of the audio signals via the audio system of the vehicle 30, ie, via the vehicle loudspeaker 31. This operational readiness can be indicated on the display 35 by a corresponding message, as indicated in FIG. 5 with the text “Karaoke, My Melody, Your Voice”.

In the usage situation of the karaoke module 20 shown in FIG. 3, the control unit 14 can be designed to detect the removal of the microphone 11 from the microphone receptacle 17 and, in this case, to start the output of the audio signals via the loudspeaker 13 on the karaoke module side.

The karaoke module 20 can have an energy transmission device (not shown) coupled to the rechargeable energy storage device 15, which is designed to transmit electrical energy provided by the vehicle 30 to the rechargeable energy storage device 15 and to charge it when the housing 12 is received in the module receptacle 33 of the vehicle 30.

### LIST OF REFERENCE NUMERALS

10 portable karaoke module
11 microphone
12 housing
13 speaker
14 control unit
15 rechargeable energy storage
16 operating unit
17 microphone receptacle
20 portable karaoke module
21 device receptacle
22 mobile terminal device
23 carrying handle
24 metal ring
25 fabric covering
26 lighting element
27 light ring
28 lighting element
30 vehicle
31 audio system: vehicle speakers
32 audio system: vehicle control unit
33 module receptacle
34 center console
35 display

1. A portable karaoke module for use in a vehicle with a vehicle-integrated audio system comprising: at least one microphone and a housing in which at least one loudspeaker, an electronic control unit for selectively outputting audio signals via the loudspeaker, and a rechargeable energy storage device for supplying energy to the loudspeaker and the control unit are accommodated, wherein an operating unit for manual function control and at least one microphone receptacle for mechanically receiving the microphone are provided on an outer side of the housing, wherein the housing is designed to be received in a corresponding module receptacle in the vehicle, and the control unit is designed to output the audio signals via the loudspeaker when the housing is not accommodated in the module receptacle, and otherwise to output the audio signals automatically via the audio system of the vehicle.

2. The portable karaoke module according to claim 1, wherein the microphone receptacle has a push-push locking mechanism for receiving the microphone.

3. The portable karaoke module according to claim 1, wherein the microphone receptacle is designed as a hollow cylinder having a height corresponding to the length of the microphone.

4. The portable karaoke module according to claim 1, further comprising: a detection device coupled to the control unit, which is designed to detect the reception of the housing in the module receptacle of the vehicle and to signal the detected reception to the control unit.

5. The portable karaoke module according to claim 1, further comprising an energy transmission device coupled to the rechargeable energy storage device, which is designed to transmit electrical energy provided by the vehicle into the rechargeable energy storage device and to charge it when the housing is received in the module receptacle of the vehicle.

6. The portable karaoke module according to claim 1, further comprising a device receptacle for a mobile terminal device provided on the outside of the housing.

7. The portable karaoke module according to claim 1, wherein the control unit is designed to detect removal of the microphone from the microphone receptacle and, in this case, to start the output of the audio signals via the loudspeaker and/or the audio system of the vehicle.

8. A vehicle comprising an integrated audio system having at least one vehicle loudspeaker and a vehicle control unit for selectively outputting audio signals via the vehicle loudspeaker, and a module receptacle configured to receive a portable karaoke module according to claim 1.

9. The vehicle according to claim 8, wherein the module receptacle is arranged in a center console.

10. The vehicle according to claim 8, wherein the module receptacle is designed as a recess having an insertion depth corresponding to a height of the housing of the karaoke module.

11. The portable karaoke module according to claim 2, wherein the microphone receptacle is designed as a hollow cylinder having a height corresponding to the length of the microphone.

12. The portable karaoke module according to claim 2, further comprising: a detection device coupled to the control unit, which is designed to detect the reception of the housing in the module receptacle of the vehicle and to signal the detected reception to the control unit.

13. The portable karaoke module according to claim 3, further comprising: a detection device coupled to the control unit, which is designed to detect the reception of the housing in the module receptacle of the vehicle and to signal the detected reception to the control unit.

14. The portable karaoke module according to claim 2, further comprising an energy transmission device coupled to the rechargeable energy storage device, which is designed to transmit electrical energy provided by the vehicle into the rechargeable energy storage device and to charge it when the housing is received in the module receptacle of the vehicle.

15. The portable karaoke module according to claim 3, further comprising an energy transmission device coupled to the rechargeable energy storage device, which is designed to transmit electrical energy provided by the vehicle into the rechargeable energy storage device and to charge it when the housing is received in the module receptacle of the vehicle.

16. The portable karaoke module according to claim 4, further comprising an energy transmission device coupled to the rechargeable energy storage device, which is designed to transmit electrical energy provided by the vehicle into the rechargeable energy storage device and to charge it when the housing is received in the module receptacle of the vehicle.

17. The portable karaoke module according to claim 2, further comprising a device receptacle for a mobile terminal device provided on the outside of the housing.

18. The portable karaoke module according to claim 3, further comprising a device receptacle for a mobile terminal device provided on the outside of the housing.

19. The portable karaoke module according to claim 4, further comprising a device receptacle for a mobile terminal device provided on the outside of the housing.

20. The portable karaoke module according to claim 5, further comprising a device receptacle for a mobile terminal device provided on the outside of the housing.
